(19) United States
(12) Patent Application Publication
(10) Pub. No.: US 2010/0325687 A1
(43) Pub. Date: Dec. 23, 2010

(54) Systems and Methods for Custom Device Automatic Password Management

(76) Inventors: Gyle T. Iverson, Woodland Hills, CA (US); Timothy A. Cope, West Hills, CA (US); Joseph J. Balint, Oak Park, CA (US); Jeffery Nielsen, Simi Valley, CA (US)

Correspondence Address: SHEPPARD, MULLIN, RICHTER & HAMPTON LLP, 990 Marsh Road, Menlo Park, CA, 94025, US

(21) Appl. No.: 12/571,292

(22) Filed: Sep. 30, 2009

Related U.S. Application Data
(63) Continuation-in-part of application No. 12/497,429, filed on Jul. 2, 2009.
Application No. 12/497,429 is a continuation-in-part of application No. 12/571,231, filed on Sep. 30, 2009.
(60) Provisional application No. 61/219,359, filed on Jun. 22, 2009.

(51) Int. Cl. G06F 21/22; H04L 9/32; G06F 9/44

(52) U.S. Cl. 726/1; 717/134; 726/6; 726/4; 717/126

(57) ABSTRACT

In various embodiments, a method comprises receiving a custom login script from a first user, receiving a custom change password script from the first user, logging onto an account on a digital device using the custom login script from the first user, changing an old password on the account to a new password at predetermined intervals using the custom change password script from the first user, receiving a password request from a second user, approving the password request, and checking out the new password to the second user.

### CROSS-REFERENCE TO RELATED APPLICATION

The present application seeks priority of U.S. Nonprovisional patent application Ser. No. 12/497,429, filed Jul. 2, 2009, entitled “Systems and Methods for A2A and A2DB Security Using Program Authentication Factors,” U.S. Provisional Patent Application No. 61/219,359, filed Jun. 22, 2009, entitled “Systems and Methods for A2A and A2DB Security Using Program Authentication Factors,” and U.S. Nonprovisional patent application Ser. No. 12/571,231, filed Sep. 30, 2009, entitled “Systems and Methods for Automatic Discovery of Systems and Accounts,” which are all hereby incorporated by reference herein.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

1. Field of the Invention

The present invention relates generally to password management. More particularly, the invention relates to systems and methods for custom device automatic password management.

2. Description of Related Art

Often too many users of a network are granted full, unrestricted superuser, root, or administrator privileges, regardless of whether or not they need this access all the time and regardless of whether they need access to perform their current duties. This “all trusting” environment is frequently coupled with a lack of accountability of this access. Unfortunately, these privileged accounts are often exploited by unethical insiders and hackers to perpetrate fraud, theft, and damage.

In response to the possible damages caused by an “all trusting” environment, some administrators administrate privileged and embedded passwords. However, due to the depth of access that privileged and embedded passwords provide to highly sensitive and confidential information, and the fact that these access credentials are shared among administrators, it is only natural that security experts and compliance auditors are recommending and requiring more scrutiny and control in this area. Without a system of checks and balances and overall accountability for privileged and embedded passwords, an organization lays itself open to exploitation and exposes its mission-critical systems to intentional or accidental harm and malicious activity that is difficult and costly to repair.

### SUMMARY

In various embodiments, a method comprises receiving a custom login script from a first user, receiving a custom change password script from the first user, logging onto an account on a digital device using the custom login script from the first user, changing an old password on the account to a new password at predetermined intervals using the custom change password script from the first user, receiving a password request from a second user, approving the password request, and checking out the new password to the second user.

The method may further comprise testing the custom login script from the first user and/or testing the custom change password script from the first user. The method may also comprise receiving a custom hash script from the first user and generating a hash of the new password with the hash script. The user may generate the custom login script and/or the custom change password script.

The method may further comprise generating a user interface to receive the custom login script. The method may also further comprise generating a terminal emulation window to test the custom login script.

In some embodiments, the method may further comprise logging onto another account on another digital device using a standard library, the standard library not including the custom login script from the first user. Further, the method may comprise changing an old password on the other account to a new password at predetermined intervals, using the standard library.

An exemplary system may comprise a custom login module, a custom change password module, and a password management module. The custom login module may be configured to receive a custom login script from a first user and log into an account on a digital device using the custom login script. The custom change password module may be configured to receive a custom change password script from the first user and change an old password on the account to a new password at predetermined intervals using the custom change password script. The password manager module may be configured to receive a password request from a second user, approve the password request, and check out the new password to the second user.

In various embodiments, a computer readable medium may comprise instructions. The instructions may be executable by a processor to perform a method. The method may comprise receiving a custom login script from a first user, receiving a custom change password script from the first user, logging onto an account on a digital device using the custom login script from the first user, changing an old password on the account to a new password at predetermined intervals using the custom change password script from the first user, receiving a password request from a second user, approving the password request, and checking out the new password to the second user.

### BRIEF DESCRIPTION OF THE DRAWINGS

FIG. 1 illustrates a security appliance that manages passwords in a heterogeneous computing environment in an embodiment.

FIG. 2 is a block diagram comprising a security appliance in an embodiment.

FIG. 3 is an exemplary method for custom device management in an embodiment.

FIG. 4 depicts a manage custom devices page in an embodiment.

FIG. 5 is an interface display of a general tab window within a custom platform description designer page in an embodiment.

FIG. 6 is an interface display of the login custom script table in an embodiment.

FIG. 7 is an interface display of the change password custom script table in an embodiment.

FIG. 8 is an interface display of the get hash custom script table in an embodiment.

FIG. 9 is an interface display of the check password custom script table in an embodiment.

FIG. 10 is a block diagram of an exemplary digital device.

### DETAILED DESCRIPTION OF THE INVENTION

In order to manage the security of a changing environment, a security system such as a password management system may be configured to log into systems (e.g., digital devices, services, applications, and files) of one or more networks to manage one or more passwords. In some embodiments, when the security system manages passwords, the security system may change a password at predetermined times or intervals. The password may be particularly complex and generated by the security system. When a user, digital device, or application wishes access to a managed system, the security system may approve a password request before checking out the current password to the user or digital device.

In some embodiments, the security system may maintain a management library of standard programs (e.g., code or scripts) to log into a system, change the password, check the password, and generate a hash of the password. The standard programs of the management library may be used for most common systems. If a system is uncommon, however, then the standard programs may be unable to perform the functions of password management for that system. For example, when a system is new (e.g., the system is a new device or a new model) then a standard program may not be available to manage the new system. In another example, some systems may be modified or configured such that they no longer respond to the standard programs.

The security system may allow users such as an administrator to create, update, and test custom programs to log into, change the password, check password, and/or generate a hash of a password of a system. In some embodiments, the security system generates a user interface that allows users to create scripts for one or more devices. In one example, a user may generate a custom login script and a custom change password script for a new device. After the user is satisfied with the scripts (e.g., through testing), the new scripts may be added to the management library. The security system may use the scripts to access and change the password for one or more devices.

Although scripts are described herein, those skilled in the art will appreciate that any kind of code may be created (e.g., by a user or automatically by a digital device such as a security system) to log into, change the password, check the password, and/or get a password hash of a system.

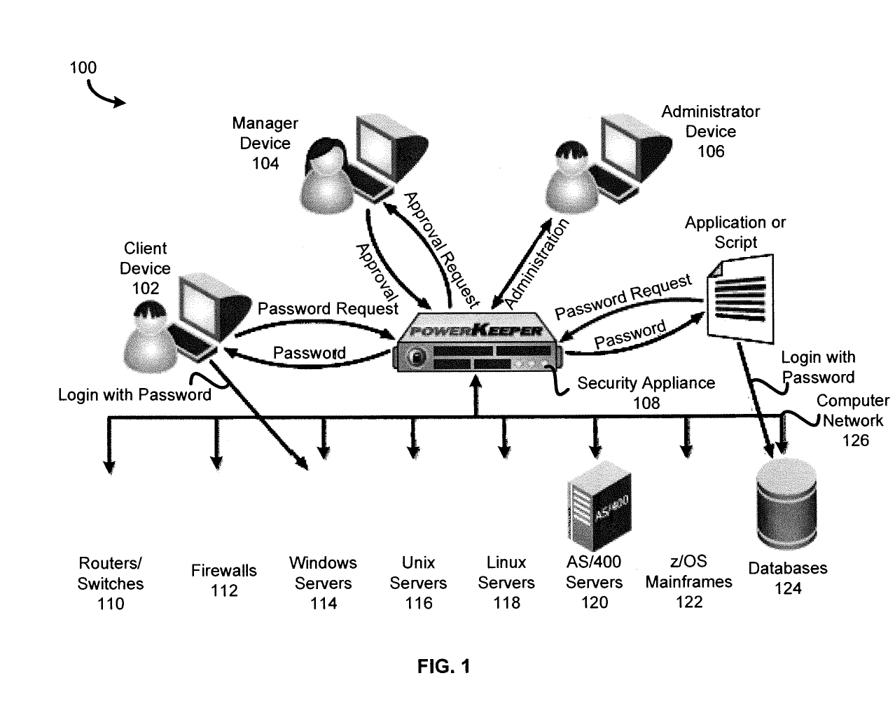

FIG. 1 illustrates a security appliance 108 that manages passwords in a heterogeneous computing environment 100 in an embodiment. The heterogeneous computing exemplary environment 100 comprises a client device 102, a manager device 104, and an administrator device 106 which may each communicate with the security appliance 108. Routers/switches 110, firewalls 112, Windows servers 114, UNIX servers 116, Linux servers 118, AS/400 servers 120, z/OS mainframes 122, and databases 124 may each be operatively coupled to a computer network 126 which may be operatively coupled to the security appliance 108.

In various embodiments, a digital device may comprise the client device 102, the manager device 104, the administrator device 106, the security appliance 108, routers/switches 110, firewalls 112, the Windows servers 114, the UNIX servers 116, the Linux servers 118, the AS/400 servers 120, the z/OS mainframes 122, and/or the databases 124. A digital device is any device with a processor and memory such as a computer. Digital devices are further described herein.

In various embodiments, a user at the client device 102 may wish access to another digital device (e.g., one of the Windows servers 114). The client device 102 may provide the security appliance 108 a password request that identifies the user and the device to be accessed (e.g., log onto one of the Windows servers 114 and/or one or more accounts on the Windows server). Upon approval, the security appliance 108 may check out a password to the user. In some embodiments, approval may be automatic (e.g., based on prior approval of the user and/or client device 102) or the approval may not be automatic (e.g., approval is required from a manager at manager device 104). In one example, the security appliance 108 receives the password request and determines if the password request may be automatically approved. If automatic approval is not available or allowed, the security appliance 108 may forward the password request (or information regarding the password request) to the manager device 104 for approval (e.g., by a manager at the manager device 104). Those skilled in the art will appreciate that there are many ways in which the password request may be approved.

In some embodiments, the client device 102 is any digital device with an application that may seek access to a secured application and/or secured database. In one example, the user of the client device 102 may be an accountant and the seeking application may be Microsoft Access. The accountant may wish to access a secured accounting database on a network (e.g., stored within the databases 124). Before the seeking application gains access to the secured accounting database, a request to access the database (e.g., a registration request) may be approved.

Once approved, the client device 102 may receive a password (e.g., the password is checked out to the user and/or client device 102) to be stored within the client device 102. Alternately, the password is not stored within the client device 102 but rather the client device 102 may receive the password when the seeking application requests access to the secured application. In some embodiments, the password may be associated with an expiration event after which the password is expired and the client device 102 must then request another password.

A seeking application is any application that is required a password or other authentication information before accessing a secure application and/or secured database. A secured application is any application that requires a password or other authentication information before being able to access the secured application. Similarly, a secured database is any database that requires a password or other authentication information before access is granted.

The manager device 104 is any digital device that may approve a registration request and/or a password request. In some embodiments, a registration request may be provided by the client device 102. The registration request may include information about the user of the client device 102, the client device 102, itself, and/or the seeking application. The manager and/or an application on the manager device 104 may review the registration request and approve or deny the request. In one example, the manager device 104 is operated by a manager that may approve the registration request from the client device 102. In another example, the manager device 104 may be configured to automatically approve the registration request. In some embodiments, the manager of the manager device 104 may approve one or more components of the registration request (e.g., program factors discussed herein) and the manager device 104 is configured to approve the same or different components of the registration request.

In some embodiments, the security appliance 108 may receive, from a user, a password request that does not require approval. The security appliance 108 may then check out a password to the user. Further, if a password request is received from an application, and the seeking application is approved based on validity of program factors, the security appliance 108 may check out a password to the seeking application. If the user submits a password request that requires approval the security appliance 108 may forward the password request as well as any other information (e.g., user identifier and/or seeking application information) to the manager and/or manager device. Similarly, if a seeking application submits a password request and the seeking application is not confirmed based on program factors, the security appliance 108 may forward the password request as well as any other to the manager and/or manager device.

Program factors may comprise application authentication factors and system authentication factors. A few examples of program authentication factors include a program name, program version, program executable hash, dependent DLL or shared library names, and dependent DLL or shared library versions. In one example, the program factors include the name of the seeking application as well as the version number of the seeking application. In some embodiments, the security appliance 108 makes a hash of the executable file of the seeking application and includes the hash as a program factor. Further, the security appliance 108 may include the name or copy one or more DLL libraries that the seeking application depends on (and/or shared library names) within the program factors. Further, the security appliance 108 may include the version number of one or more DLL libraries and/or shared libraries in the program factors. In some embodiments, the program authentication factors may be used to confirm that the seeking application is authentic as opposed to malware posing as an otherwise authorized seeking application. Those skilled in the art will appreciate that the program factors are not limited to only those identified herein, but may include other information regarding the seeking application, the user, or the client device 102.

Those skilled in the art will appreciate that there may be any number of ways a manager and a managing device 104 may, either in combination or separately, review and examine registration requests for approval or denial. Further, those skilled in the art will appreciate that the manager device 104 may be optional and the approval process may take place within the security appliance 108 (further described herein) and/or the administrator device 106.

The administrator device 106 is any digital device that configures the security appliance 108. In various embodiments, the administrator device 106 is operated by an administrator (e.g., a network administrator, security officer, or IT professional) who can configure the security appliance 108. In one example, the administrator device 106 may display a configuration interface (e.g., a web page from the security appliance 108) that allows configuration. The administrator device 106 may configure the security appliance 108 to perform different tasks depending upon the seeking application, the user of the user device 102, and/or the user device 102. In one example, the administrator device 106 may specify specific manager devices 104 which must approve a registration request from a specific user name before the registration request may be approved and access to a secured application provided (e.g., via a password). The administrator device 106 may also specify program factors that must be confirmed as well as what the values of the program factors are expected to be. Those skilled in the art will appreciate that the security appliance 108 may be configured in any number of ways.

The security appliance 108 is a security system that may comprise hardware, software, or a combination of both. In various embodiments, a digital device comprises the security appliance 108. The digital device may be cabled to (or otherwise in communication with) the computer network 126. In some embodiments, the security appliance 108 may comprise software configured to be run (i.e., executed) by a server, router, or other device. The security appliance 108 may also comprise hardware. For example, the security appliance 108 may comprise a Windows 2003 server (such as a hardened Windows 2003 server or a hardened Windows 2008 server), with quad-core CPUs, hot swap mirrored drives, redundant power supplies, and redundant fans. The security appliance 108 may also comprise redundant CPUs and hot-bank memory.

In various embodiments, the security appliance 108 is configured (e.g., by an administrator and/or the administrator device 106) to provide security for systems of a network. In some embodiments, the security appliance 108 generates and changes passwords to a system. A system that has one or more passwords changed by the security appliance is a managed system. The password generated by the security appliance 108 may be complex. In some embodiments, the password is generated based on rules established by one or more administrators. The security appliance 108 may generate new passwords and exchange existing passwords in favor of the newly generated passwords at predetermined times or intervals. Further, the security appliance 108 may be configured to process registration requests, log relevant information, and check out passwords to users, applications, and/or digital devices.

In one example of the security appliance 108 processing registration requests, prior to a seeking application on a client device 102 being allowed to access a secured application or secure database, the security appliance 108 may require registration. The user device 102 may then provide a registration request to the security appliance 108. The registration request may include information regarding the user, the client device 102, and/or the seeking application. Based on a prior configuration, the security appliance 108 may, based on the user, the client device 102, and/or the seeking application, review the registration request and/or route the registration request to one or more manager devices 104 for approval. In one example, the security appliance 108 may be configured to determine if the client device 102 and/or the user logged into the client device 102 have rights to the secured application and/or secured database. If the client device 102 and/or the user do not have rights, the security appliance 108 may be configured to deny the registration request. The security appliance 108 may also be configured to email or otherwise contact one or more manager devices 104 to receive approval for the registration request. For example, the administrator may configure the security appliance 108 to email all registration requests associated with a particular seeking application to a predetermined number of managers and/or manager devices 104. In some embodiments, the security appliance 108 may not approve the registration request until all managers and/or manager devices approve the registration.

The security appliance 108 may also be configured to generate and/or change passwords for accounts. In some examples, the accounts may allow access one or more systems (i.e., digital devices, services, files, and/or applications). The security appliance 108 may be configured to generate complex passwords to the accounts and change the passwords at predetermined times or intervals. In some embodiments, the security appliance 108 may check out a current password to the user of the client device 102 and then subsequently change the password thereby increasing security by implementing complex passwords that change over time. In one example, the security appliance 108 determines an expiration event at set intervals (e.g., every few seconds, minutes, hours, and/or days), at set times (e.g., at 1:05 AM every day), or at set times and dates (e.g., 3:00 AM on the 15^{th} of a month). Those skilled in the art will appreciate that there are many ways to schedule one time or recurring events to trigger creation of a new password and/or changing existing passwords to accounts.

In some embodiments, the security appliance 108 manages a system through a functional account. The functional account is a managed account that may be dedicated solely for the security appliance's exclusive use to perform necessary password management functions. A managed account is a user account on a managed system whose password is managed by the security appliance 108.

In various embodiments, the functional account may have a password or a DSS key credential in place of a password. Using DSS key credentials may provide increased security for the functional account when the functional account is also configured without a password. In such cases, it may not be possible for an individual to login to the device using the function account credentials. In some embodiments, this provides a clear audit trail as to who (or what) used the functional account's credentials to login to the device.

In various embodiments the security appliance 108 is configured to generate the password to the secure application and/or secured application. In one example, a method to create a password to a specific secured database (e.g., a secured SQL database) is stored within and executable by the security appliance 108. For example, the method may comprise executable instructions which are executable by a processor to perform a method of creating or changing a password for one or more secured applications and/or secured databases. The security appliance 108 may interact directly with one or more digital devices, secured applications, and/or secured databases to create or change the password.

The security appliance 108 may also change the password to the secured application and/or the secured database. In various embodiments, as discussed herein, the security appliance 108 determines an expiration event after which a password is expired (e.g., after a predetermined time or date). At that time, the security appliance 108 will change the password to the secured application and/or the secured database. In one example, the security appliance 108 interacts with the secured application and/or the secured database to change the password and then the security appliance 108 may store the password.

It will be appreciated by those skilled in the art that the security appliance 108 may encrypt the password and/or encrypt storage where the password is stored. Further, the security appliance 108 may encrypt all communications between the security appliance 108 and any other digital device (e.g., all communication between the client device 102 and the security appliance 108 may be encrypted). In various embodiments, the security appliance 108 performs FIPS-140 validated encryption of data and communications, access control mechanisms, secure storage of credentials, secure audit trails. The security appliance 108 may also comprise a sealed operating system.

The security appliance 108 may also be configured to log all registration requests, passwords, password changes, and password requests thereby creating a record of the activities of each user, client device 102, and/or seeking application. In some embodiments, the logs of the security appliance 108 may be used to confirm that the secured application and/or the secured database are being used as approved. The logs may also be encrypted. In various embodiments, the logs may be audited (e.g., by the administrator and/or the administrator device 106). The security appliance 108 may also be configured to provide reports regarding user/approver, requester activities, password maintenance, user and file entitlement (rights) and/or internal diagnostics. In a few examples, the reports may be exportable in CSV and HTML formats.

Although FIG. 1 shows curved lines between the client device 102 and the security appliance 108, the manager device 104 and the security appliance 108, as well as the administrator device 106 and the security appliance 108, those skilled in the art will appreciate that the client device 102, manager device 104, and administrator device 106 may not be each directly connected to the security appliance 108. In one example, the client device 102, manager device 104, and administrator device 106 may be in communication with the security appliance 108 over one or more networks. The curved lines in FIG. 1 may depict the nature of the communication between a digital device and the security appliance 108. In one example, in order to receive a password to log into the Windows servers 114, the client device 102 may send a password request to the security appliance 108. The security appliance 108 may be configured by the administrator device 106 (e.g., as depicted in FIG. 1 as “administration”) to send the password request to the manager device 104 for approval. The manager device 104 may send the approval to the security appliance 108 which may then provide the password to the client device 102. The password may then be provided to the Windows servers 114. In some embodiments, the password is not visible or displayed to the user of the client device 102. In various embodiments, the password that is being checked out for an account on the Windows Server 114 may have been put in place on the Windows Server 114 at the last scheduled password rotation. After the previous password request expired, the password may be changed to prevent the previous requestor from re-accessing the server after his password checkout interval expired.

In another example, the client device 102 may comprise a seeking application or script (depicted in FIG. 1) which seeks access to a secured database. Prior to access, the client device 102 (e.g., via the seeking application or script) may provide the password request to the security appliance 108 which may either provide the password or provide the password after the proper approvals have been obtained. The password may then be checked out to the client device 102 which may log into the secured database with the password to obtain access.

Those skilled in the art will appreciate that the security appliance may not be limited to password management. Although various embodiments described herein refer to generating, changing, and providing passwords to access the secured host, the secured application and/or the secured database, those skilled in the art will appreciate that similar systems and methods may be used with any form of security, including the issuance of encryption keys (e.g., private or public keys), certificates, digital signatures, decryption keys, credentials as well as rights management to files, volumes, and/or devices. In various embodiments, instead of a password being provided to the client device 102, the security appliance 108 may alter user rights such that the user may view, access, make changes to, and/or share the secured application and or secured database. In some embodiments, the security appliance 108 may provide a password to the client device 102 as well as make changes to file rights. In exemplary embodiments, the security appliance 108 may provide access in many ways.

In some embodiments, a seeking application on the client device 102 may be required to provide a registration request for rights to a program or database on another digital device. The rights may include, but are not limited to, rights to view, access, make changes, and share with other users. The security appliance 108 may perform similar tasks as when a password is requested. In one example, the security appliance 108 may examine the registration request and analyze program factors to ensure that the seeking application is authorized and/or authenticated. The registration request may also be approved by one or more manager devices 104. Upon approval, the security appliance 108 may grant any number of rights to access the application or database. Further, the security appliance 108 may generate a new password for the sought application or database and/or provide the password to the client device 102.

In various embodiments, when a seeking application requests a password for the first time or when a change in program factors is requested, registration may be required. A registration request presents the program factors for the seeking application so the program factors can be approved by a user (e.g., manager or administrator) with program administrator role.

Although the security appliance 108 is depicted as communicating directly over the computer network 126, the security appliance 108 may also communicate indirectly over the computer network 126. In one example, the security appliance 108 may be a part of or otherwise coupled to the client device 102, the manager device 104, the administrator device 106, the security appliance 108, the routers/switches 110, the firewalls 112, the Windows servers 114, the UNIX servers 116, the Linux servers 118, the AS/400 servers 120, the z/OS mainframes 122, and the databases 124. Alternately, those skilled in the art will appreciate that there may be multiple networks and the security appliance 108 may communicate over all, some, or one of the multiple networks. In some embodiments, the computer network 126 comprises a bus.

The security appliance 108 may comprise a software library that provides a programmatic interface to the security appliance 108. In one example, an API library resident on the security appliance 108 may have a small set of functions that are rapidly mastered and readily deployed in new or existing applications. There may be several API libraries, for example one library for each computer language or technology, such as, Java, .NET or C/C++ languages. Each specific instance, the API library may provide the same set of functions.

The routers/switches may comprise any number of routers and/or switches. In some embodiments, the security appliance 108 may manage rights or access to one or more routers or switches. The client device 102 may be required to provide a registration request and receive approval before rights to access the routers or switches are approved. The routers/switches 110 may comprise Cisco routers and switches for example. In another example, the routers/switches 110 may comprise a Terminal Access Controller Access-Control System (TACACS). The routers/switches 110 may also comprise web proxies or caches including, but not limited to, BlueCoat Security Gateway devices.

The firewalls 112 may comprise hardware, software, or a combination of both hardware and software. Control to access and manage the firewalls 112 may be controlled by the security appliance in a method similar to that described herein. In one example, before the user of the client device 102 is permitted to access and/or configure the firewall 112, the client device 102 may be required to provide a registration request that must be approved. In a few examples, the firewalls 112 may comprise Cisco PIX, Netscreen, Nokia IPSO, Check Point, or Cyberguard.

The Windows servers 114 may include any server configured with a Microsoft Windows operating system. In a few examples, the Microsoft operating system may be Windows 2000, 2003, XP, Media Center, Active Directory, NT 4.0, NT Domains, Vista, and Windows 7.

The UNIX servers 116 may include any server configured with a UNIX operating system. In a few examples, the UNIX operating system may be Solaris, AIX, HP-UX, Tru64, or UNIXWare. Similarly, the Linux server 118 may be any server configured with the Linux operating system. In a few examples, the Linux operating system may be Red Hat or Suse.

The AS/400 servers 120 and the z/OS servers 122 may include any server(s) with the associated operating system. Further a server may be configured with RACF, HP iLo, VMware, BoKS, Fujitus RSB, and Radius.

The databases 124 may comprise hardware, software, or a combination of hardware and software. In one example, the databases 124 are on a file server. The databases may include Oracle databases, Microsoft SQL, Sybase, MySQL, DB2 or any other database for example.

Those skilled in the art will appreciate that many operating systems, databases, and applications may be in communication with or otherwise coupled to the computer network 126. The examples listed herein are not intended to be limiting and other operating systems, databases, and applications may be used in conjunction with various embodiments described herein.

The computer network 126 may provide communication between the client device 102, the manager device 104, the administrator device 106, the security appliance 108, routers/switches 110, firewalls 112, the Windows servers 114, the UNIX servers 116, the Linux servers 118, the AS/400 servers 120, the z/OS mainframes 122, and/or databases 124. In some embodiments the computer network 126 represents one or more network(s) which one or more digital devices may use to communicate. In some examples, the computer network 126 comprises Ethernet cables, fiber optic, or other wired network topology. In other examples, the computer network 126 may be wireless and support wireless communication between two or more wireless devices. Those skilled in the art will appreciate that the computer network 126 may comprise two or more networks, including wired and wireless networks.

Although the routers/switches 110, the firewalls 112, the Windows servers 114, the UNIX servers 116, the Linux servers 118, the AS/400 servers 120, the z/OS mainframes 122, and the databases 124 are discussed as plural, those skilled in the art will appreciate that there may be any number of (including one or zero) routers/switches 110, the firewalls 112, the Windows servers 114, the UNIX servers 116, the Linux servers 118, the AS/400 servers 120, the z/OS mainframes 122, and the databases 124 and be within embodiments described herein.

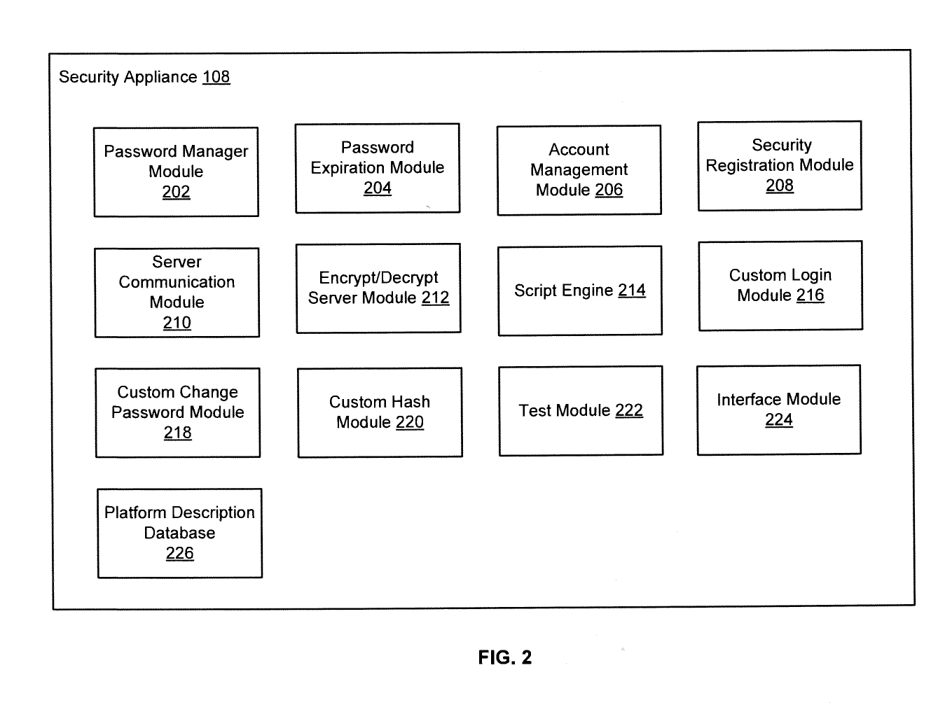

FIG. 2 is a block diagram comprising a security appliance 108 in an embodiment. The security appliance 108 may apply tools for rapid implementation of security management services to one or more systems and/or accounts. In some embodiments, the security appliance 108 may be configured to utilize a platform description to access a system, change the password, test the password, and/or generate a hash of a password.

A platform description contains detailed information which describes a system. In one example, an administrator may associate a system with a platform description. The security appliance 108 may use the platform description to access a system, change the password of the system, test the password, and/or generate a hash of a password. In one example, the platform description may describe a system such that, when one or more variables of the platform description are defined (e.g., the address of a system), the security appliance 108 may utilize the platform description to manage the system.

In some embodiments, a platform description may describe a type of digital device. The security appliance 108 may use the platform description to access one or more digital devices with the same device type using the platform description. For example, an administrator using the security appliance 108 may associate multiple devices of a similar type with the same platform description. The administrator may then configure a series of variables of the platform description associated with each of the multiple devices. Variables, for example, may include address information that is different for each different device of the same type. In other embodiments, the platform description is defined (e.g., no variables are used in the platform description). Those skilled in the art will appreciate that some of the security appliance 108 may use some platform descriptions comprising variables and some platform descriptions that do not comprise variables.

Platform descriptions may be standard or custom. A standard platform description is a description that is not created by a user. Typically, standard platform descriptions describe common and/or popular systems. In some embodiments, the security appliance 108 comprises a platform description library (further described herein). The platform description library may comprise standard platform descriptions, custom platform descriptions, or a combination of both standard and custom platform descriptions. The security appliance 108 may use standard platform descriptions to communicate and perform functions with a wide variety of “standard” or common systems.

A user may create their own platform descriptions (i.e., custom platform descriptions), as necessary, to allow the security appliance 108 to perform automatic password management for systems in the environment which may not be supported by standard platform descriptions. In one example, the system is too new and a standard platform description has not been created for the system. In another example, the system may be configured in such a way that the system no longer responds as expected and/or as required to the security appliance 108 using the standard platform description.

A user may create a custom login script, a custom change password script, a custom hash script, and/or a custom check password script. The user may also store the scripts associated to one or more systems or system types in the custom platform description. The user may test the scripts to ensure that they perform as expected and debug the custom platform description as necessary. When testing is satisfactory, the user may associate the custom platform description with one or more systems. The user may also define any variables as necessary such that the security appliance 108 accesses and performs the correct function on the correct associated system.

In various embodiments, the security appliance 108 may be configured to scan a directory structure (e.g., a Microsoft Active Directory) for systems (e.g., digital devices, services, applications, and files) and/or accounts associated with the systems. A directory structure is any structure that may comprise manageable systems and/or manageable accounts. The security appliance 108 may then generate a scan result. In one example, the security appliance 108 may be configured to scan a domain to find new systems to manage.

The security appliance 108 may also scan for systems and then allow an administrator to select which systems and/or associated accounts to be managed by the security appliance 108. In some embodiments, the security appliance 108 allows the administrator (e.g., via a selection interface) to select systems and/or accounts to be managed. The administrator may also be able to select groups of systems, accounts, or combinations of both.

The security appliance 108 comprises a password manager module 202, a password expiration module 204, an account management module 206, a security registration module 208, a server communication module 210, an encrypt/decrypt server module 212, a script engine 214, a custom login module 216, a custom change password module 218, an custom hash module 220, a test module 222, an interface module 224, and a platform description database 226.

The password manager module 202 may be configured to control the security appliance 108. The password manager module 202 may be configured to change a password for an account. The account may be associated with any system. In one example, the password manager module 202 creates a new password to an administrator account for a file server (e.g., using a platform description). The password manager module 202 may then create a new password to replace the old password at an expiration event (further described herein). In various embodiments, one or more administrators and/or digital devices may define criteria for new passwords. In some examples, the criteria may require that a password comprise more (e.g., above a threshold), less (e.g., below a threshold), and/or an exact number of special characters, letters, uppercase letters, lowercase letters, and/or numbers. The criteria may also require that the password comprise a number between two thresholds (e.g., above a lower threshold and below an upper threshold) of special characters, letters, uppercase letters, lowercase letters, and/or numbers.

In some embodiments, the password manager module 202 comprises a library of executable instructions (e.g., a platform description database of platform descriptions) which are executable by a processor for changing the password to a system such as a secured application or secured database. The library may comprise any number of methods for generating or changing passwords to any number of secured programs or secured databases. For example, a program stored in the library may be configured to change the password to a SQL database.

Once a password is generated or otherwise changed, the password expiration module 204 may determine an expiration event for the password. In some embodiments, the expiration event may be a few minutes before the password is changed and a new expiration event determined. Alternately, the expiration event may be hours, days, weeks, or longer. Before expiration, passwords that are generated or changed can be used by the client device 102. In some embodiments, once the password is changed and the password expiration module 204 determines the expiration event, the password manager module 202 provides the password and the expiration event to the client device 102 which may store the password and the expiration event.

In some embodiments, the password manager module 202 may receive a password request from the client device 102. The account management module 206 may then determine if the password request is authentic and authorized (e.g., via one or more program factors that may be received with the password request). In one example, the account management module 206 identifies the user, the client device 102, and/or the seeking application based on the password request and/or any program factors accompanying the password request. The account management module 206 may maintain separate accounts for each user, client device 102, seeking application, and/or any combination of the three. A program account may be similar to a CLI user account but the program account may be maintained and stored in the security appliance 108.

The account management module 206 may be configured to confirm one or more program factors. The program factors may be a part of a registration request from the client device 102, password request, or challenge factor response. During registration, the account management module 206 may request that the security agent 202 collect any number of program factors. The account management module 206 may then store the program factors. In one example, during registration, the account management module 206 may request the path of the executable for the seeking program from the client device 102 as well as a program executable hash. This information may be stored and used to confirm program factors later received if the registration is successful. In one example, previously stored program factors may be used to confirm program factors associated with a password request from the client device 102.

In some embodiments, the administrator device 106 may configure the account management module 206 to store acceptable values of program factors. In one example, the administrator device 106 identifies acceptable IP addresses, OS types, CPU serial numbers, executable hash values, user IDs and the like. The account management module 206 may receive program factors to be used to allow, confirm, and/or authenticate program factors later received from the client device 102 in any number of ways including both from the client device 102 and the administrator device 106. In one example, program factors that are used to allow, confirm, and/or authenticate other program factors may be provided by the client device 102, the manager device 104, and/or the administrator device 106.

When the account management module 206 receives program factors from the client device 102, the account management module 206 may compare the program factors (after decryption) to previously stored values to determine if the program factors are approved and authentic. In other embodiments, one or more of the program factors may be authenticate and/or confirmed by a manager device 104.

The security registration module 208 is configured to receive the registration request from the client device 102. In some embodiments, the security registration module 208 may first receive a password request from a seeking program on the client device 102 and then determine if the seeking application is registered. If the application is not registered, the security registration module 208 may send a request to the client device 102 for the registration request. In some embodiments, the request identifies one or more program factors that the client device 102 is to provide for approval of the registration request.

During registration, the security registration module 208 may examine one or more program factors received from the client device 102. In some embodiments, the security registration module 208 compares the program factors received from the client device 102 to predetermined values configured by the administrator device 106. Further, the administrator device 106 may configure the security registration module 208 to provide one or more of the program factors to one or more manager devices 104 for approval. In some embodiments, the same program factors may be approved by one or more manager devices 104 (or managers of the manager devices 104) as well as the security registration module 208. In one example, one or more program factors may be approved by the security registration module 208. One or more of the program factors and the registration request may then be forwarded (e.g., via email) to one or more manager devices 104 for approval. If the security registration module 208 determines that there is not a match, then the security registration module 208 may deny the registration request and the program factors and the registration request are not forwarded.

When the security registration module 208 forwards the registration request and the program factors to the one or more manager devices 104, the security registration module 208 may be configured to wait a predetermined period of time or when all approvals are received. In some cases, based on the configuration by the administrator device 106, any number of the program factors and/or the registration request may be approved by the manager devices 104 (or the approvers of the manager device 104). If the predetermined time expires and not all approvals are received, the security registration module 208 may deny the request. Further, if one denial is received at any time, the security registration module 208 may deny the request. If the request is denied, the seeking application may not be able to access the secured application and/or secured database.

The server communication module 210 is configured to provide communication between the security appliance 108 and the client device 102. The client communication module 210 may also be configured to communicate between the security agent 202 and the security appliance 108.

The encrypt/decrypt server module 212 may be configured to provide encryption, decryption, or other security measures for the security appliance 108. In some embodiments, the encrypt/decrypt server module 212 issues a program key. A program key can be an SSH DSS private key or an X509v3 client certificate, for example. The security appliance 108 may issue a program key for use on behalf a program account. In some embodiments, the program key may be a required parameter for API functions.

In some embodiments, the security appliance 108 does not allow direct access to the OS on the security appliance 108. Further, the security appliance 108 may comprise a firewall (e.g., with IPSEC support) to prevent hacking. Moreover, the security appliance 108 may perform encryption, such as FIPS-140 validated components, and perform hard disk AES 256-bit encryption for whole disk encryption. Passwords, once generated, may be stored with x509v3 certificates. In some embodiments, inbound connections may be only through HTTPS and SSH. The security appliance 108 may also support single- or two-factor authentication using LDAP Active Directory, SecureID, Safeword, and x509v3 certificates. The security appliance 108 may perform any or more than the functions listed herein.

The script engine 214 is configured to execute one or more codes and/or scripts. In various embodiments, the script engine 214 is configured to execute the custom login script, the custom change password script, the custom check password script, and/or the custom hash script. In some embodiments, the script engine 214 may be used to help test code or scripts.

In some embodiments, the script engine 214 includes an interface that allows a user to generate code or script to log into a system with a custom login script received from the custom login module 216. Those skilled in the art will appreciate that embodiments described herein are not limited to any particular programming language or script.

The custom change password module 218 is configured to receive, test, and store custom change password scripts. A custom change password script is a script or other code configured to allow the security appliance 108 to change the password of a system. In some embodiments, the custom change password module 218 includes an interface that allows a user to generate code or script to change the password of a system. Once custom change password script has been created and tested (e.g., with the script engine 214), the custom change password module 218 may store the custom change password script within the platform description database 226.

The custom hash module 220 is configured to receive, test, and store custom hash scripts. A custom hash script is a script or other code configured to allow the security appliance 108 to take a hash function of a password of a system. In some embodiments, the custom hash module 220 includes an interface that allows a user to generate code or script to get the hash of a password of a system. Once custom hash script has been created and tested, the custom hash module 220 may store the custom get hash script within the platform description database 226.

The test module 222 is configured to provide an interface to allow testing of the custom login script, the custom change password script, the custom check password script, and/or the custom hash script. In some embodiments, the test module 222 generates a terminal window for the user to test one or more scripts. The terminal window may support the ANSI terminal standard or a subset of the ANSI terminal standard, including, but not limited to VT 100 terminal type and, at least partially, may cover VT220.

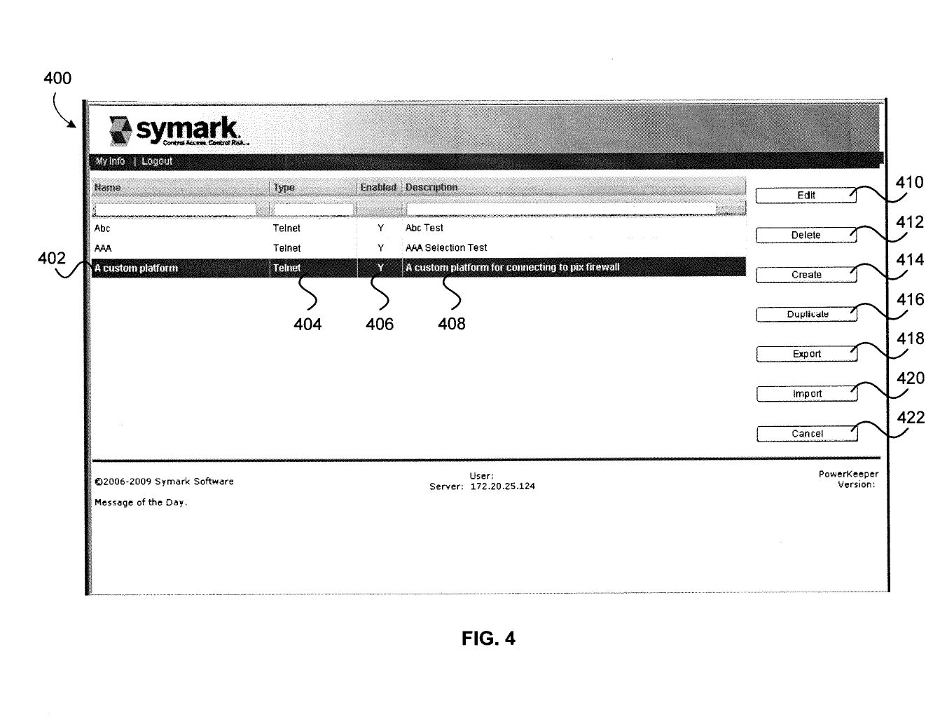

The interface module 224 may display any number of windows and interfaces including an interface to receive the custom login script, the custom change password script, the custom check password script, and the custom get hash script. The interface module 224 may also be configured to display the terminal window of the test module 222. Examples of displays that may be displayed by the interface module 224 include FIGS. 4-9.

The platform description database 226 is any data structure that is configured to store one or more platform descriptions (e.g., standard platform descriptions and/or custom platform descriptions). Those skilled in the art will appreciate that although the platform description database 226 is described as a database, the platform description database 226 may comprise any data structure or combination of data structures.

In some embodiments, the password manager module 202 is configured to allow a user to associate a custom platform description or a standard platform description to any number of systems. When the user associates a custom platform description with a system, for example, variables associated with the custom platform description may be defined with information from the system. In some embodiments, the act of associating the custom platform description with the system defines the variables. One or more variables may also be defined for a platform description by the user or the password manager module 202.

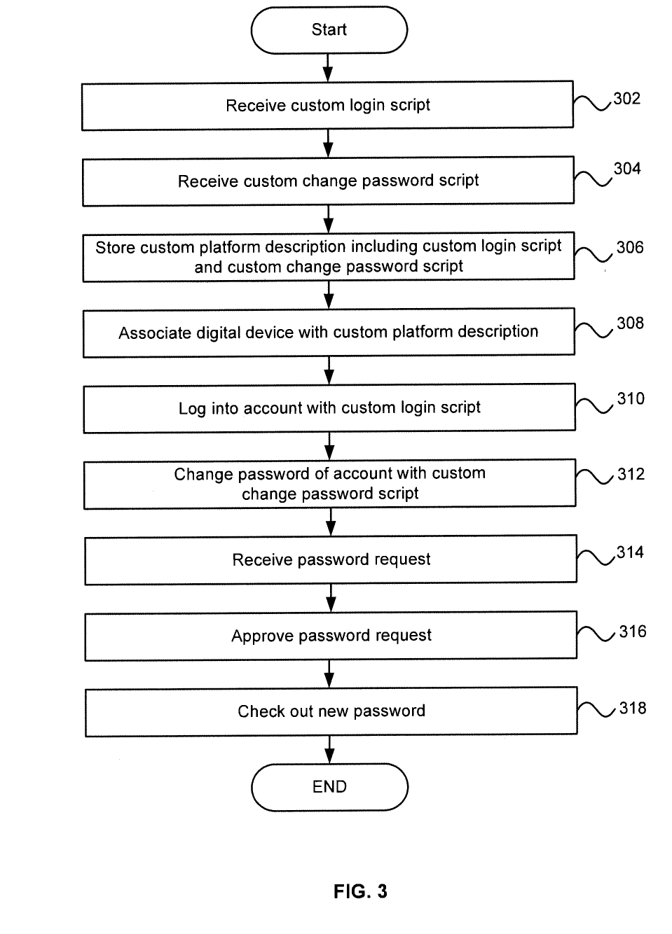

FIG. 3 is an exemplary method for custom device management in an embodiment. In step 302, the custom login module 216 receives a custom login script. The custom login script may be used to log into or otherwise access a system (e.g., log into or otherwise access an account associated with a system). In some embodiments, a user creates the custom login script via an interface generated by the interface module 224. The custom login script may be configured for a nonstandard system (e.g., a system that is not responsive to the security appliance 108 using a standard platform description).

In step 304, the custom change password module 218 receives a custom change password script. The custom change password script may be used to change the password of a system (e.g., change the password of an account associated with a system). In some embodiments, the user creates the custom change password script via the interface generated by the interface module 224.

In step 306, the password manager module 202, interface module 224, or the custom login module 216 may store the custom platform description including the custom login script and the custom change password script within the platform description database 226.

In step 308, the password manager module 202 may associate a system (e.g., a digital device) with the custom platform description. In some embodiments, a user may associate one or more systems with the custom platform description using a user interface generated by the interface module 224.

In step 310, the password manager module 202 may log into an account associated with the system using the custom login script. In one example, the password manager module 202 identifies a system and retrieves a platform description (e.g., the custom platform description) from the platform description database 226. The password manager module 202 may then use the custom platform description to access the associated system. For example, the password manager module 202 may use the custom login script within the custom platform description to log into the system.

In step 312, the password manager module 202 may change a password of an account of the system using the custom change password script to change an old password to a new password. For example, after the password manager module 202 using the custom platform description to log into the system, the password manager module 202 may generate a new password and then use the custom change password script from within the custom platform description to change the old password of the system (e.g., an account associated with the system) to a new password. In some embodiments, the password manager module 202 may use the custom platform description to log into and change the password of one or more associated systems at predetermined times or intervals.

In step 314, the password manager module 202 receives a password request for the system. In one example, the password request may be received from a user or user device 102. The password manager module 202 may approve or receive approval for the password request in step 316. In some embodiments, the password manager module 202 may determine if the password request may be automatically approved. If the password request may not be automatically approved, the password manager module 202 may forward the password request or forward information associated with the password request to a manager or manager device 104 for approval.

Once the password request is approved, in step 318 the password manager module 202 may check out the new password of the system (e.g., a new password for an account associated with the system) to the user and/or user device 102.

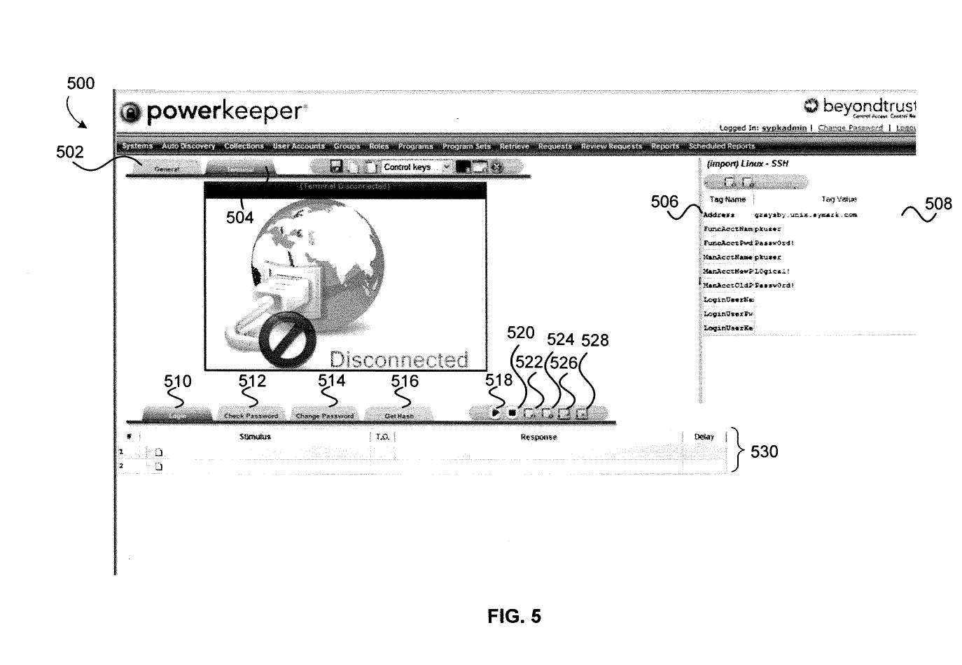

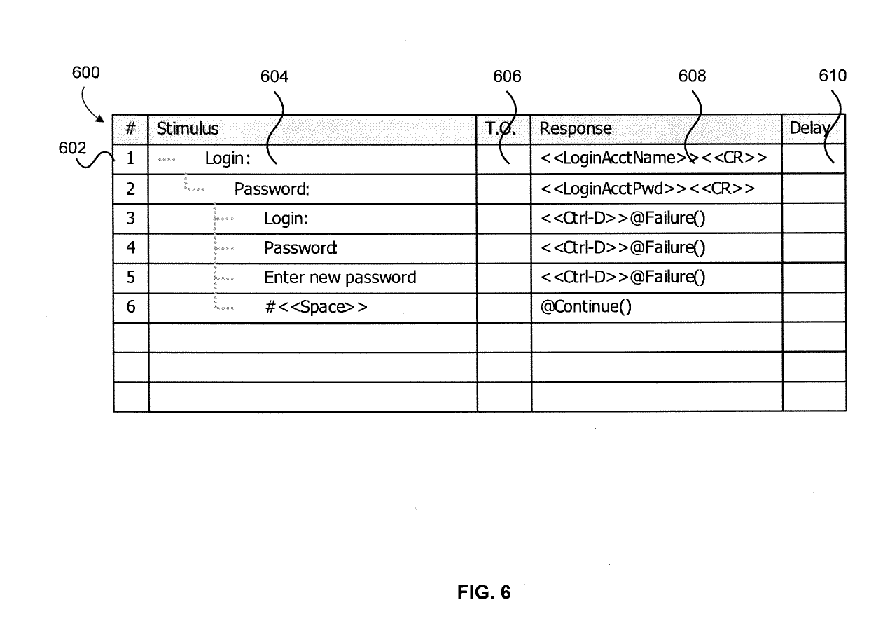

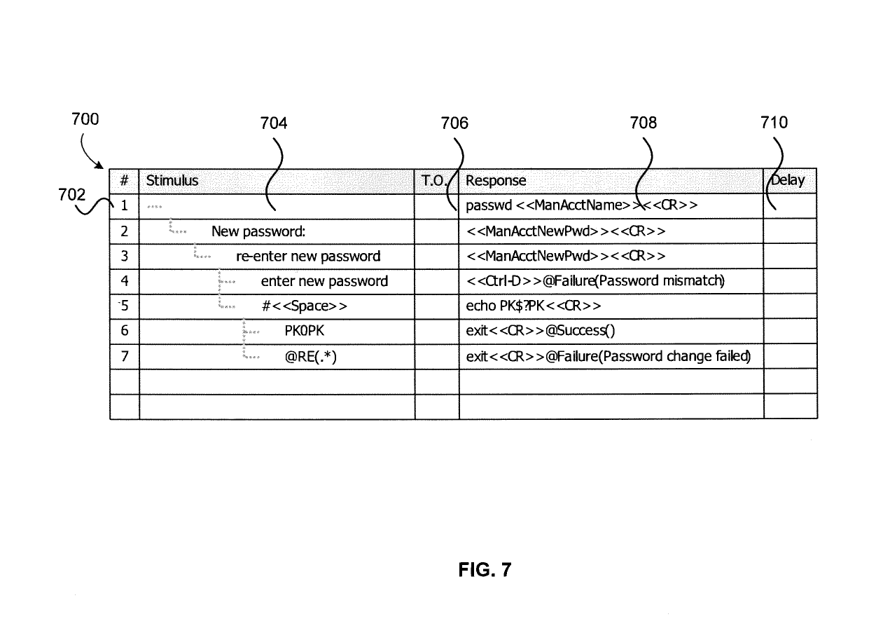

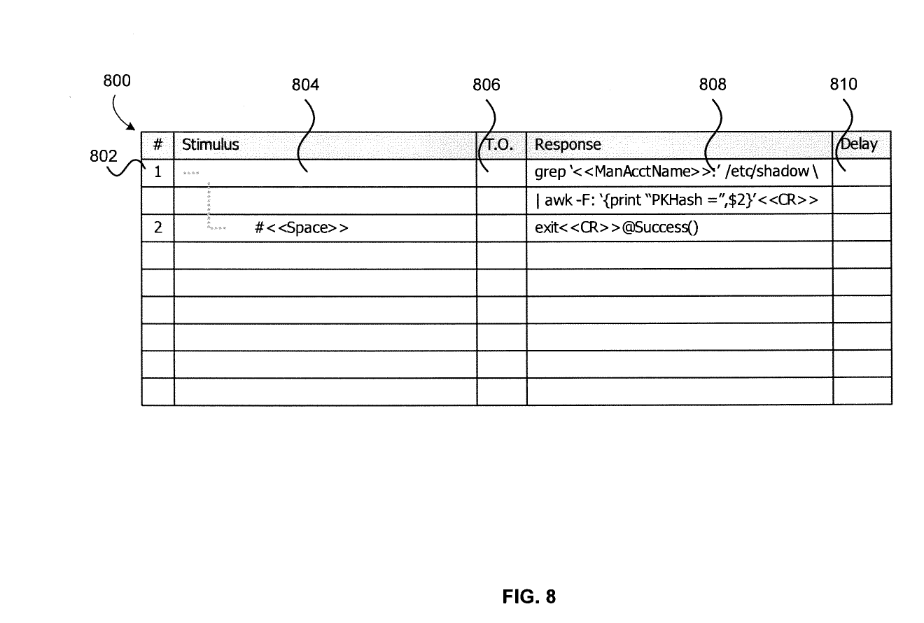

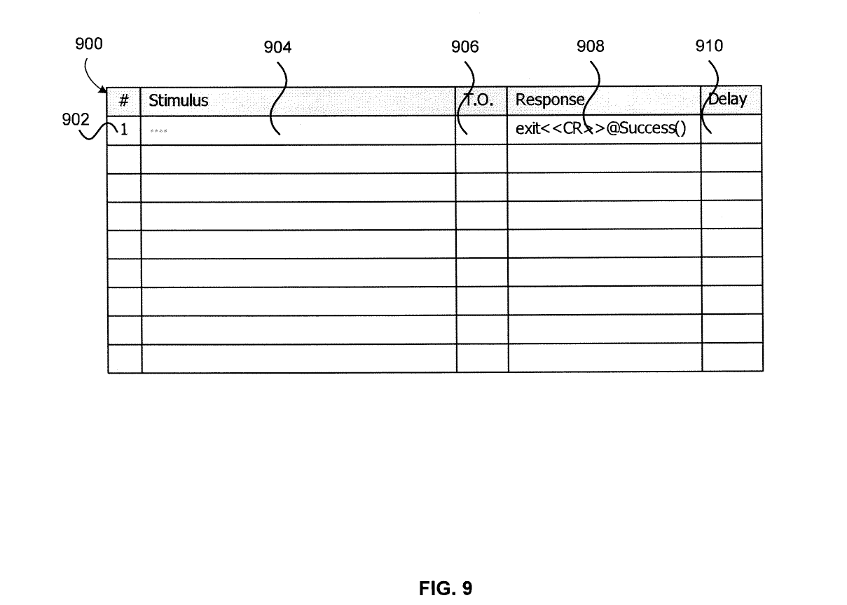

FIG. 4 depicts a manage custom devices page 400 in an embodiment. In various embodiments, the manage custom devices page 400, general tab window 500 (see FIG. 5), login custom script table 600 (see FIG. 6), change password custom script table 700 (see FIG. 7), the get hash custom script table 800 (see FIG. 8), and the check password custom script table 900 (see FIG. 9) are web pages, documents, and/or other interfaces for a user and may be generated by the interface module 224.

The manage custom devices page 400 may be used to create, edit, delete, duplicate, export or import a custom platform description. The custom platform description may comprise a custom login script, a custom change password script, a change password script, and/or a custom hash script. In some embodiments, the manage custom devices page 400 may display a summary of a plurality of custom platform descriptions. The filter selection page 400 comprises a plurality of name fields 402, type fields 404, enabled fields 406, and description fields 408. The manage custom devices page 400 may also comprise an edit button 410, a delete button 412, a create button 414, a duplicate button 416, an export button 418, an import button 420, and a cancel button 422.

Although the manage custom devices page 400 is entitled “manage custom devices,” those skilled in the art will appreciate that the manage custom devices page may be used to create, edit, delete, duplicate, export, and import the custom platform description for any system.

The name field 402 is a field for the name of a custom platform description. The name may be generated by the password manager module 202 or the user through the manage custom devices page 400. Three name fields 402 depicted in FIG. 4 show names “Abc,” “AAA,” and “A custom platform.” In some embodiments, a user may alter the name in one or more name fields 402 on the manage custom devices page 400.

The type field 404 indicates the type of connection that may be used with the custom platform description. In some examples, the custom platform description may connect to a system via telnet or SSH (e.g., version 1, 2, or 3). Those skilled in the art will appreciate that the type of connection may be any kind of connection.

The enabled field 406 indicates if the custom platform description is enabled or not enabled. When a custom platform description is enabled, the custom platform description may be available to the password manager module 202 to perform various functions on one or more systems. If the custom platform description is not enabled, the custom platform description may not be available to the password manager module 202.

In some embodiments, the user may seek to associate a system with a platform description. The user may select from any number of enabled platform descriptions (standard platform descriptions and/or custom platform descriptions). If a platform description is not enabled, however, the selection may be unavailable and the user may not associate the platform description with the system. In some embodiments, a user may enable or disable a custom platform description by changing the value in the enabled field 406.

The description field 408 is a field for the description of the custom platform description. The description may describe the type of system and/or function of the custom platform description. The description may be generated by the password manager module 202 or the user through the manage custom devices page 400. Three description fields 408 depicted in FIG. 4 show names “Abc test,” “AAA Selection Test,” and “A custom platform for connecting to pix firewall.” In some embodiments, a user may alter the description in one or more description fields 408 on the manage custom devices page 400.

If the user activates the edit button 410, the user may edit an existing custom platform description. In some embodiments, the user may alter, update, or otherwise modify an existing custom platform description. In some examples, the user selects a custom platform description by clicking a mouse button to select a name, type, enablement, or description of a custom platform description. The user may then activate the edit button 410 to edit the selected custom platform description. When a user edits an existing custom platform description, the user may make changes to a custom login script, custom change password script, custom hash script, and/or a check password script. The user may also test or enable the selected custom platform description.

If the user activates the delete button 412, the user may delete a selected custom platform description. If the user activates the duplicate button 416, the user creates a duplicate of a selected custom platform description. The user may then make changes to an existing custom platform description and save the changes by saving the custom platform description as a new custom platform description.

If the user activates the export button 418 or the import button 420, the user may export the selected custom platform description or import a custom platform description, respectively. When a user exports a custom platform description, the user may export the custom platform description to a different security appliance 108. In one example, when the user exports the custom platform description, the custom platform description is exported as a file which may be transferred to a different security appliance 108.

When a user imports a custom platform description, the user may import the custom platform description from a different security appliance 108 to the current security appliance 108. The custom platform description may then be stored and used in the security appliance 108. Those skilled in the art will appreciate that, in some embodiments, a custom platform description and/or a security appliance 108 may be configured to share the custom platform description automatically with one or more other security appliances.

When the user activates the cancel button 422, the manage custom devices page 400 may close.

FIG. 5 is an interface display of a terminal tab window within custom platform description designer page 500 in an embodiment. In some embodiments, the description designer page 500 is generated by the interface module 224 and is configured to allow a user to create and test a code or script for the custom login script, custom change password script, custom hash script, or custom check password script. The terminal tab window comprises a general tab 502, a terminal tab 504, a plurality of tag name fields 506, a plurality of tag value fields 508, a login tab 510, a check password tab 512, a change password tab 514, a get hash tab 516, a play button 518, a stop button 520, an add row button 522, a delete row button 524, a tab button 526, and a remove tab button 528.

When the user activates the general tab 502, a general window may appear. The general window may allow a user to create or add name or description that may be used by one or more script tags (further discussed herein). The general window may also allow the user to select a channel (e.g., SSH or telnet) or identify a port that may be used while testing one or more custom scripts. Further, the general window may also allow the user to enable SSH options so that a DSS key is used during testing and/or PTY is allocated for testing. In some embodiments, the user may also require that a managed account, rather than a functional account, is used for testing. Those skilled in the art will appreciate that the user may define many script tags and configure many options for testing the custom scripts.

In some embodiments, the general tab 502 may generate a window that gives the user the option to automatically negotiate a communication protocol with a system. In one example, the security appliance 108 may attempt to communicate with the system over SSH version 3. If unsuccessful, the security appliance 108 may attempt to communicate with the system over SSH version 2, and then attempt version 1 if that is unsuccessful. The security appliance 108 may attempt to communicate with the system over any number of communication protocols.

When the user activates the terminal tab 504, a terminal emulation window may appear to allow communication with a system and testing of various codes and scripts. In FIG. 5, the terminal emulation window indicates that there is no current communication with a service (i.e., “disconnected). The terminal emulation window may support any kind of terminal emulation including, but not limited to, any ANSI compatible terminal emulator including a VT 100 terminal type and, at least partially, may cover VT220. In some embodiments, a user may communicate with the system via telnet or SSH version 1, 2, or 3. Those skilled in the art will appreciate that the terminal emulation window may allow for communication with any terminal type and over any communication protocol.

The login scripts may include tag names identified in tag name field(s) 506. Each script tag name in the tag name field 506 may be represented by a character string in tag value field 508. In one example, a custom login script may comprise one or more script tags. When the custom login script is run (e.g., by the script engine 214), the script tag names may be replaced by the associated tag value in the tag value field 508.

The tag name field 506 comprises a field for a script tag name. In some embodiments, the script tags are named objects that have an associated character string value (depicted in the tag value field 508). Script tags may be logically equivalent to variables in a programming language. The names of the script tags may be defined by the security appliance 108 or the user. In some embodiments, the user may define additional script tags. A tag name in the tag name field 506 may be defined as the tag value (e.g., character string value) in the tag value field 508.

The character string value (i.e., the tag value in the tag value field 508) may be defined by the security appliance 108 when a custom script (e.g., custom login script) is executed by the script engine 214. The character string values may represent information from the system and/or account associated with the system being managed. Examples of script tags include the following:

| | | |
|---|---|---|
| <<Address>> | Dynamic | System network address |
| <<Port>> | Dynamic/Static | Protocol port number |
| <<FuncAcctName>> | Dynamic | Function account name |
| <<FuncAcctPwd>> | Dynamic | Functional account password |
| <<FuncAcctKey>> | Dynamic | Functional account DSS key |
| <<ManAcctName>> | Dynamic | Managed account name |
| <<ManAcctOldPwd>> | Dynamic | Managed account old password |
| <<ManAcctNewPwd>> | Dynamic | Managed account new password |
| <<LoginUserName>> | Dynamic | Login account name |
| <<LoginUserPwd>> | Dynamic | Login account password |
| <<LoginUserKey>> | Dynamic | Login account DSS key |
| <<Timeout>> | Static | Timeout seconds |
| <<CharacterDelay>> | Static | Character delay in hundredths of a second |
| <<LineDelay>> | Static | Line delay in hundredths of a second |

The script tag names listed above use capital letters to assist readability. The script engine 214 may not be sensitive to the casing of the script tag name characters. For example, the <<TO>>, <<To>> and <<to>> forms may be equivalent.

The script tags may be placed into the platform description connection string or within the custom script tables (further described herein). Prior to the execution of a custom script, the script engine 214 may replace occurrences of script tags with the current character string value assigned to the respective script tag.

There may also be several pre-defined special character script tags for representing non-printing and control characters. The first three columns in the table, below, represents examples of valid special character script tag names:

| Control | ANSI | Alternate | Ordinal | |
|---|---|---|---|---|
| Tag | Tag | Tag | Value | Description |
| Ctrl-@ | NUL | | 0 | Null |
| Ctrl-A | SOH | | 1 | Start of Heading |
| Ctrl-B | STX | | 2 | Start of Text |
| Ctrl-C | ETX | | 3 | End of Text |
| Ctrl-D | EOT | | 4 | End of Transmission |
| Ctrl-E | ENQ | | 5 | Enquiry |
| Ctrl-F | ACK | | 6 | Acknowledged |
| Ctrl-G | BEL | | 7 | Bell |
| Ctrl-H | BS | | 8 | Backspace |
| Ctrl-I | TAB | | 9 | Horizontal Tab |
| Ctrl-J | LF | NL | 10 | Line Feed or New Line |
| Ctrl-K | VT | | 11 | Vertical Tab |
| Ctrl-L | FF | NP | 12 | Form Feed or New Page |
| Ctrl-M | CR | | 13 | Carriage Return |
| Ctrl-N | SO | | 14 | Shift Out |
| Ctrl-O | SI | | 15 | Shift In |
| Ctrl-P | DLE | | 16 | Data Link Escape |
| Ctrl-Q | DC1 | X-ON | 17 | Device Control 1 |
| Ctrl-R | DC2 | | 18 | Device Control 2 |
| Ctrl-S | DC3 | X-OFF | 19 | Device Control 3 |
| Ctrl-T | DC4 | | 20 | Device Control 4 |
| Ctrl-U | NAK | | 21 | Negative Acknowledge |
| Ctrl-V | SYN | | 22 | Synchronous Idle |
| Ctrl-W | ETB | | 23 | End of Transmission Block |
| Ctrl-X | CAN | | 24 | Cancel |
| Ctrl-Y | EM | | 25 | End of Medium |
| Ctrl-Z | SUB | | 26 | Substitute |
| Ctrl-[ | ESC | | 27 | Escape |
| Ctrl-\ | FS | | 28 | File Separator |
| Ctrl-] | GS | | 29 | Group Separator |
| Ctrl-\hat{ } | RS | | 30 | Record Separator |
| Ctrl-_{—} | US | | 31 | Unit Separator |
| | Space | | 32 | Space |
| | DEL | | 127 | Delete |

The script tag names listed above may not be reserved names and may be redefined by the user or security appliance 108 as needed. If redefined, the script engine 214 may use the script tags defined by the security appliance 108 rather than the user defined script tags. Alternately, the script engine 214 may be configured to use the user defined script tags rather than the script tags defined by the security appliance 108.

The login tab 510, check password tab 512, change password tab 514, and the get hash tab 516 may each be associated with a different script table 530. In one example, when the login tab 510 is active, the script table 530 is displayed. The user may then program or write the custom login script using the script table 530. When the check password tab 512 is active, the user may then program or write the custom check password script. Similarly, when the change password tab 514 is active, the user may program or write the custom change password script. Further, when the get hash tab 516 is active, the user may program or write the custom hash script. The user may also click on a tab to edit a previously written script.

The play button 518 may activate the script appearing in the script table 530. In one example, the user may activate the login tab 510 and create a custom login script. The user may then activate the play button 518 to test the script. The script engine 214 may execute the custom login script in the script table 530 using a terminal window provided by the test module 222.

The stop button 520 may stop a script from executing. In one example, the script may not be performing as expected or errors may occur. The user may activate the stop button 520 to stop the script from continuing to execute.

The user may also activate the add row button 522 or remove row button 524. When the add row button 522 is activated, the script table 530 may add one or more additional rows. When the remove row button 524 is activated, the script table may remove one or more rows. When a row is added or removed, the row may be added or removed from the bottom of the table. In some embodiments, the row may be added or removed from any part of the table.

The add tab button 526 and the remove tab button 528 may add a tab or remove a tab, respectively, to the code or script in one or more cells of the script table 530.

FIG. 6 is an interface display of the login custom script table 600 in an embodiment. The login scrip table comprises a step field 602, a stimulus field 604, a timeout (i.e., T.O.) field 606, a response field 608, and a delay field 610. The user of the interface display may use the login custom script table 600 to code or script a custom login script.

The custom script table 600 comprises stimulus and response fields. A stimulus in the stimulus field 604 contains information that the security appliance 108 expects to receive from the system. The response in the response field 608 contains information that will be the security engine's response to the stimulus.

The stimulus column may contain constant character strings, references to script tag names, or regular expressions (further described herein). The example in FIG. 6 depicts the stimulus values as constant character strings. Any script tag name may be included in the stimulus column in addition to constant character strings.

The stimulus column may be a tree structure in which the row indentation indicates the hierarchical relationship between two or more rows. In the example in FIG. 6, row 2 is indented under row 1 which may indicate that row 2 will not be evaluated (or executed) until row 1 successfully evaluates (or is executed). In one example, rows 1 and 2 may be stated as; IF row 1 successfully evaluates, THEN advance to row 2. This is similar to an IF-THEN logical structure found in numerous computer programming languages.

Rows 3 through 6 of the example in FIG. 6 depict another logical structure option. These four rows may all be evaluated simultaneously or near simultaneously. When one of the four stimulus conditions occurs, the response for that row will be sent and execution will advance to the children of the matched row. This logical structure is similar to a select or CASE statement found in numerous computer programming languages. The logical indentation may continue as deeply as required.

The response column may contain constant character strings, script tags, and/or actions. These may be freely interspersed within the response column. The substitution of tag values may occur prior to sending the response to the system. Actions may be removed from the response prior to sending. The actions may direct the script engine 214 to stop the evaluation of the custom login script and return either success or failure. The actions may include an optional message character string to assist in later log review.

In various embodiments, there are three explicit actions and one implied action. The explicit actions include @Success( ), @Failure, and @Continue. The implied action is the timeout action which occurs whenever a set of stimulus fail to match within the allotted time period. The explicit actions may be located anywhere within the response column relative to other optional constant character strings:
@Success([message])
@Failure([message])
@Continue( )

The message may be a constant character string that may include script tags. The message may be recorded in a log. The @Continue( ) action may be reserved for use by the custom login script. The @Continue( ) action may indicate to the script engine 214 that the custom login script has successfully completed its steps. Subsequently, the custom change password script, the custom hash script, or the custom check password script may regain control and proceed to perform steps.

In one example, the custom login script may be shared by the custom change password script, the custom hash script, and the custom check password script. The custom login script may be responsible for logging into a system and returning a success or failure indication to the script engine 214. Once successfully logged in, control may be passed to the custom change password script, the custom hash script, and the custom check password script.

In some embodiments, the custom login script may use the following script tags: <<LoginUserID>>, <<LoginUserKey>>, and <<LoginUserPwd>>. The values of these script tags may be set by the script engine 214 based upon configurable settings (e.g., values in the tag name fields 506 and the tag value fields 508 of FIG. 5). The <<LoginUserID>> and <<LoginUserPwd>> values may be assigned the values from the <<ManAcctName>> and <<ManAcctOldPwd>> script tags, respectively. It is also possible for an administrator to specify that a managed account should be used rather than a functional account.

In various embodiments, the <<LoginUserID>>, <<LoginUserKey>>, and <<LoginUserPwd>> values may be assigned the values from the <<FuncAcctName>>, <<FuncAcctKey>>, and <<FuncAcctPwd>> script tags, respectively. The <<LoginUserKey>> script tag may be by the script engine 214 when using the SSH protocol with DSS keys.

The last logical stimulus row may be a command shell prompt. This row may have the value of @Success in the response. This may indicate that the custom login script has successfully logged into the system and is now ready to perform the next appropriate custom script (e.g., change password, get hash, or check password).

The step value in the step field 602 may indicate the order of the step. The step value may be generated by the security appliance 108.

The timeout value in the time out field 606 is the amount of time the custom login script will wait. If the timeout value in the time out field 606 expires and the expected stimulus is not received, then the script engine 214 may generate an error.

When a timeout action occurs, the script engine 214 may generate a timeout error message that contains the platform name, the custom script being executed, the line number where the stimulus failed, the stimulus that failed to match, and the timeout period. When a CASE grouping timeout occurs, each line number and stimulus may be included in the error message.

The delay value in the delay field 610 may specify an inter-character time delay between the sending of each character of the response, and optionally, an additional delay following of sending of the last character of the response. If no delay value is specified, there may be no inter-character or last-character delay in the sending of the response. The inter-character delay and last-character periods may be specified in any unit of time. In one example, the inter-character delay is specified in hundredths of a second. The inter-character delay and the last-character delay may be separated by a comma character (,). In one example, to specify an inter-character delay of 20/100^{th} of a second, a user may enter 20. If the delay column is empty, the values from the CharacterDelay and LineDelay script tags may be used. If these tags are empty, there may be no delay introduced by the script engine 214.

Those skilled in the art will appreciate that the test module 222 and/or the interface module 224 may provide for debugging of syntax and other errors to assist the user in creating the custom codes or scripts. For example, if syntax is incorrect, the interface module 224 may change the color or underline potential errors before the code or script is actually executed. Further, the test module 222 and/or the interface module 224 may include a tutorial as well as code and/or scripts that the user may use in creating custom scripts. The test module 222 and/or the interface module 224 may also comprise a compiler that is configured to compile code written for the custom scripts. For example, as previously discussed, the custom script may comprise code such as C, C++, Java, or any programming language as well as any scripting language. Those skilled in the art will appreciate that the test module 222 and/or the interface module 224 may perform any number of tasks to assist the user in creating, editing, and testing code and/or scripts.

FIG. 7 is an interface display of the change password script table 700 in an embodiment. The change password script table 700 comprises a step field 702, a stimulus field 704, a timeout field 706, a stimulus field 708, and a delay field 710. The user of the interface display may use the change password script table 700 to code or script a custom change password script.

The step field 702, the timeout field 706, and the delay field 710 are similar to the step field 602, the timeout field 606, and the delay field 610 of FIG. 6.

In some embodiments, the custom change password script is responsible for changing the managed account's password to the value in <<ManAcctNewPwd>> script tag and returning a success or failure indication to the script engine 214. After changing the managed account's password, the custom change password custom script may provide instruction to log out of the device and close the connection.

FIG. 8 is an interface display of the get hash custom script table 800 in an embodiment. The get hash custom script table 800 comprises a step field 802, a stimulus field 804, a timeout field 806, a stimulus field 808, and a delay field 810. The user of the interface display may use the get hash custom script table 800 to code or script a custom hash script. In some embodiments, the custom hash script may configure the security appliance 108 to generate a hash of a password for a system. The security appliance 108 may then compare a hash of an expected password to the hash of the existing password for the system to check if the existing password is different from the expected password. In some embodiments, a hash function may be used rather than logging directly into the system to check the password.

Similar to FIG. 7, the step field 802, the timeout field 806, and the delay field 810 are similar to the step field 602, the timeout field 606, and the delay field 610 of FIG. 6.

The custom hash script may be responsible for retrieving a managed account's password hash and returning the password hash and a success or failure indication to the script engine 214. After retrieving the managed account's password hash, the custom hash script may provide instructions to log out of the system and close the connection.

In some embodiments, for the password hash to be recognized by the security appliance 108, the password hash may be in the following format: PKHash=passwordHash.

The formatted password hash may be printed on its own line. The example in FIG. 8 depicts one method of retrieving the password hash for an account on a Linux-type device. The response column for row 1 is shown consuming two rows. In practice, the response column may not wrap in this manner. In addition, the backslash (\) character may be used as an indication of the line break. The \ character may not occur in practice.

FIG. 9 is an interface display of the check password script table 900 in an embodiment. The check password script table 900 comprises a step field 902, a stimulus field 904, a timeout field 906, a stimulus field 908, and a delay field 910. The user of the interface display may use the check password script table 900 to code or script a custom check password script.

Similar to FIGS. 7 and 8, the step field 902, the timeout field 906, and the delay field 910 are similar to the step field 602, the timeout field 606, and the delay field 610 of FIG. 6.

The custom check password script may be responsible for verifying that the managed account's password is valid and returning a success or failure indication to the script engine 214. After checking the managed account's password, the custom check password script may provide instruction to log out of the device and close the connection.

In various embodiments, the custom scripts and/or codes may be written in a regular expression. Those skilled in the art will appreciate that the regular expression is discussed in detail in the .NET Framework Regular Expression section of the Microsoft Developer Network (MSDN) Library. A regular expression may not include constant character strings outside of the regular expression. Instead, any constant character string must be enclosed within the regular expression. Any script tag name may be included within the regular expression. The substitution of script tag values occurs prior to evaluating the regular expression.

In various embodiments, the regular expression language is designed and optimized to manipulate text. The language comprises two basic character types: literal (normal) text characters and metacharacters. The set of metacharacters may give regular expressions processing power.

In one example, the regular expression \s2000, when applied to a body of text, matches all occurrences of the string “2000” that are preceded by any white-space character, such as a space or a tab. Regular expressions can also perform searches that are more complex. For example, the regular expression (?<char>\w)\k<char>, using named groups and backreferencing, searches for adjacent paired characters. When applied to the string “I'll have a small coffee” it may find matches in the words “I'll,” “small,” and “coffee.” Those skilled in the art will appreciate how to code and/or script using regular expression.

Those skilled in the art will appreciate that a platform description may comprise a combination of standard codes and/or scripts as well as custom scripts. In one example, a platform description may comprise standard code (e.g., code or scripts to perform functions that may be found associated with a standard platform description) to log into a system but then may deploy a custom change password script. Those skilled in the art will appreciate that the platform description may comprise many kinds of code and scripts from many sources.

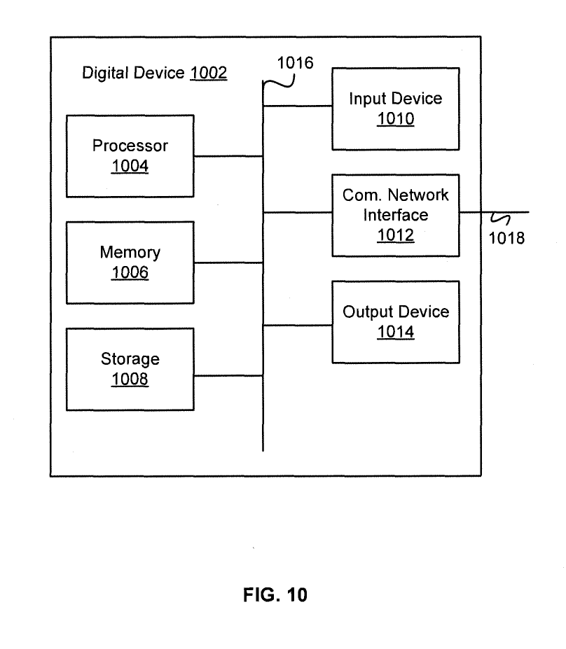

FIG. 10 is a block diagram of an exemplary digital device 1002. Any of the client device 102, the manager device 104, the administrator device 106, the security appliance 108, routers/switches 110, firewalls 112, the Windows servers 114, the UNIX servers 116, the Linux servers 118, the AS/400 servers 120, the z/OS mainframes 122, and databases 124 may be an instance of the digital device 1002. The digital device 1002 comprises a processor 1004, memory system 1006, storage system 1008, an input device 1010, a communication network interface 1012, and an output device 1014 communicatively coupled to a communication channel 1016. The processor 1004 is configured to execute executable instructions (e.g., programs). In some embodiments, the processor 1004 comprises circuitry or any processor capable of processing the executable instructions.

The memory system 1006 stores data. Some examples of memory system 1006 include storage devices, such as RAM, ROM, RAM cache, virtual memory, etc. In various embodiments, working data is stored within the memory system 1006. The data within the memory system 1006 may be cleared or ultimately transferred to the storage system 1008.

The storage system 1008 includes any storage configured to retrieve and store data. Some examples of the storage system 1008 include flash drives, hard drives, optical drives, and/or magnetic tape. Each of the memory system 1006 and the storage system 1008 comprises a computer-readable medium, which stores instructions or programs executable by processor 1004.

The input device 1010 is any device such an interface that receives inputs data (e.g., via mouse and keyboard). The output device 1014 is an interface that outputs data (e.g., to a speaker or display). Those skilled in the art will appreciate that the storage system 1008, input device 1010, and output device 1014 may be optional. For example, the routers/switchers 110 may comprise the processor 1004 and memory system 1006 as well as a device to receive and output data (e.g., the communication network interface 1012 and/or the output device 1014).

The communication network interface (corn. network interface) 1012 may be coupled to a network (e.g., computer network 126) via the link 1018. The communication network interface 1012 may support communication over an Ethernet connection, a serial connection, a parallel connection, and/or an ATA connection. The communication network interface 612 may also support wireless communication (e.g., 802.11 a/b/g/n, WiMax, LTE, WiFi). It will be apparent to those skilled in the art that the communication network interface 1012 can support many wired and wireless standards.

It will be appreciated by those skilled in the art that the hardware elements of the digital device 1002 are not limited to those depicted in FIG. 10. A digital device 1002 may comprise more or less hardware, software and/or firmware components than those depicted (e.g., drivers, operating systems, touch screens, biometric analyzers, etc.). Further, hardware elements may share functionality and still be within various embodiments described herein. In one example, encoding and/or decoding may be performed by the processor 1004 and/or a co-processor located on a GPU (i.e., Nvidia).

The above-described functions and components can comprise instructions that are stored on a storage medium such as a computer readable medium. Some examples of instructions include software, program code, and firmware. The instructions can be retrieved and executed by a processor in many ways.

The present invention is described above with reference to exemplary embodiments. It will be apparent to those skilled in the art that various modifications may be made and other embodiments can be used without departing from the broader scope of the present invention. Therefore, these and other variations upon the exemplary embodiments are intended to be covered by the present invention.

1. A method comprising:
receiving a custom login script from a first user;
receiving a custom change password script from the first user;
logging onto an account on a digital device using the custom login script from the first user;
changing an old password on the account to a new password at predetermined intervals using the custom change password script from the first user;
receiving a password request from a second user;
approving the password request; and
checking out the new password to the second user.

2. The method of claim 1, further comprising testing the custom login script from the first user.

3. The method of claim 1, further comprising testing the custom change password script from the first user.

4. The method of claim 1, further comprising receiving a custom hash script from the first user and generating a hash of the new password with the custom hash script.

5. The method of claim 1, where the first user generates the custom login script.

6. The method of claim 1, where the first user generates the custom change password script.

7. The method of claim 1, further comprising generating a user interface to receive the custom login script.

8. The method of claim 7, further comprising generating a terminal emulation window to test the custom login script.

9. The method of claim 1, further comprising logging into another account on another digital device using a standard library, the standard library not including the custom login script from the first user.

10. The method of claim 9, further comprising changing an old password on the other account to a new password at predetermined intervals, using the standard library.

11. A system comprising:
a custom login module configured to receive a custom login script from a first user and log into an account on a digital device using the custom login script;
a custom change password module configured to receive a custom change password script from the first user and change an old password on the account to a new password at predetermined intervals using the custom change password script; and
a password manager module configured to receive a password request from a second user, approve the password request, and check out the new password to the second user.

12. The system of claim 11, further comprising a custom test module configured to test the custom login script from the first user.

13. The system of claim 11, further comprising a custom test module configured to test the custom change password script from the first user.

14. The system of claim 11, further comprising a custom hash module configured to receive a custom hash script from the first user and generating a hash of the new password with the custom hash script.

15. The system of claim 11, where the first user generates the custom login script.

16. The system of claim 11, where the first user generates the custom change password script.

17. The system of claim 11, further comprising an interface module configured to generate a user interface to receive the custom login script.

18. The system of claim 17, further comprising a test module configured to generate a terminal emulation window to test the custom login script.

19. The system of claim 11, wherein the password manager module is further configured to log into another account on another digital device using a standard library, the standard library not including the custom login script from the first user.

20. The system of claim 19, wherein the password manager module is further configured to change an old password on the other account to a new password on the other account at predetermined intervals, using the standard library.

21. A computer readable medium comprising executable instructions, the executable instructions being executable by a processor to perform a method, the method comprising:
receiving a custom login script from a first user;
receiving a custom change password script from the first user;
logging onto an account on a digital device using the custom login script from the first user;
changing an old password on the account to a new password at predetermined intervals using the custom change password script from the first user;
receiving a password request from a second user;
approving the password request; and
checking out the new password to the second user.
